(19) United States
(12) Patent Application Publication
(10) Pub. No.: US 2026/0158566 A1
(43) Pub. Date: Jun. 11, 2026

(54) Pendulum Stroke Device for a Power Tool, Pendulum Stroke Unit for such a Pendulum Stroke Device, and Power Tool with such a Pendulum Stroke Device

(71) Applicant: Robert Bosch GmbH, Stuttgart (DE)

(72) Inventors: Tamas Kundrat, Miskolc (HU); Zoltan Kocsis, Miskolc (HU)

(21) Appl. No.: 19/410,274

(22) Filed: Dec. 5, 2025

(30) Foreign Application Priority Data
Dec. 9, 2024 (DE) 10 2024 211 721.8

(51) Int. Cl. B23D 49/16; B23D 51/16

(52) U.S. Cl. CPC B23D 49/165; B23D 51/16

(57) ABSTRACT

A pendulum stroke device for a power tool, in particular a sawing machine is disclosed. The pendulum stroke device has a thrust crank unit, in particular a Scotch yoke unit, for converting a rotary motion into at least essentially linear oscillation, which has at least one crank unit that can be actuated by a gear unit of the power tool and has at least one crank element with a crank axis, and includes at least one fork element, which is bounded by a receiving region for the crank element. The pendulum stroke device further has at least one lift rod, which is connected to the fork element at one axial end, for transmitting the linear oscillation to a tool holder element of the power tool with a thrust direction running essentially parallel to a main direction of extension of the lift rod. In addition, the pendulum stroke device has at least one pendulum stroke unit, which has at least one first guide element formed fixedly with the crank unit, which has a first guide surface extending essentially perpendicular to the crank axis, and at least one second guide element facing the first guide element, which is at least firmly connected to the fork element, which has a second guide surface that is at least partially oblique to the first guide surface and which, in at least one operating state, is intended to abut against the first guide surface and, when the crank unit is rotated, to cause a pendulum stroke movement of the fork element to run in a direction essentially parallel to the crank axis.

This application claims priority under 35 U.S.C. § 119 to application no. DE 10 2024 211 721.8, filed on Dec. 9, 2024 in Germany, the disclosure of which is incorporated herein by reference in its entirety.

### BACKGROUND

A pendulum stroke device for a power tool having a thrust crank unit for converting a rotary motion into at least essentially linear oscillation, which has at least one crank unit that can be actuated by a gear unit of the power tool and has at least one crank element with a crank axis, and comprises at least one fork element, which is bounded by a receiving region for the crank element, and at least one lift rod, which is connected to the fork element at one axial end, for transmitting the linear oscillation to a tool holder element of the power tool with a thrust direction running essentially parallel to a main direction of extension of the lift rod, has already been proposed.

### SUMMARY

The disclosure relates to a pendulum stroke device for a power tool, in particular a sawing machine, having a thrust crank unit, in particular a Scotch yoke unit, for converting a rotary motion into at least essentially linear oscillation, which has at least one crank unit that can be actuated by a gear unit of the power tool and has at least one crank element with a crank axis, and comprises at least one fork element, which is bounded by a receiving region for the crank element, and at least one lift rod, which is connected to the fork element at one axial end, for transmitting the linear oscillation to a tool holder element of the power tool with a thrust direction running essentially parallel to a main direction of extension of the lift rod.

It is proposed that the pendulum stroke device has at least one pendulum stroke unit, which has at least one first guide element formed fixedly with the crank unit, which has a first guide surface extending essentially perpendicular to the crank axis, and at least one second guide element facing the first guide element, which is at least firmly connected to the fork element, which has a second guide surface that is at least partially oblique to the first guide surface and which, in at least one operating state, is intended to abut against the first guide surface and, when the crank unit is rotated, to cause a pendulum stroke movement of the fork element to run in a direction essentially parallel to the crank axis.

The embodiment of the pendulum stroke device according to the disclosure can advantageously achieve particularly effective cutting. A pendulum stroke movement can be superimposed with an advantageously simple mechanism of linear oscillation. Furthermore, a particularly high degree of flexibility can be provided with regard to different movement profiles of a pendulum stroke device. Furthermore, a particularly simple and particularly cost-effective design can be advantageously provided. Furthermore, an advantageously robust design of the pendulum stroke device can be provided. A particularly long service life of the pendulum stroke device can be achieved. It is possible to achieve a particularly high level of operating convenience and particularly efficient use of a power tool.

The pendulum stroke device is preferably designed to convert a rotary motion of a drive unit of a power tool into an essentially linear oscillation with a thrust direction of a machining tool running essentially perpendicular to the crank axis and to transfer it to the machining tool arranged on the tool holder element of the power tool. In at least one operating state, the pendulum stroke device is designed to superimpose a pendulum stroke movement in a direction essentially parallel to the crank axis on this linear oscillation. The drive unit of the power tool preferably comprises an electric motor, particularly preferably a brushless electric motor. It is particularly preferred that the power tool is battery-powered. Alternatively, the power tool is designed as a corded power tool. However, it would also be conceivable for the drive unit of the power tool to have an internal combustion engine. The tool holder element of the power tool for holding a machining tool is preferably designed as a clamping device, particularly preferably as a quick-release fastener. The tool holder element is preferably designed in particular for holding saw blades with an S-shank. It would also be conceivable that the tool holder element has, for example, a screw for fixing a machining tool. Furthermore, other embodiments of the tool holder element that appear sensible to a person skilled in the art are also conceivable. The machining tool may in particular be a sawing tool, such as a saw blade, a cutting tool, an abrasive, or the like. The machining tool preferably has a machining surface arranged in a plane extending essentially parallel to the linear oscillating movement, such as teeth of a saw blade, a blade of a cutter, a grain of an abrasive, or the like. Preferably, the machining tool has a straight machining surface. Alternatively, it would be conceivable for the machining surface of the machining tool to be curved, for example with a circular arc-like or parabolic shape or the like. “Provided” is understood in particular as meaning specifically adapted, specifically programmed, specifically designed and/or specifically equipped. The fact that an object is provided for a specific function should be understood in particular to mean that the object fulfills and/or executes this specific function in at least one application state and/or operating state.

The lift rod is primarily intended to transfer the linear oscillation and the pendulum stroke movement to the tool holder element of the power tool. The linear oscillation moves essentially parallel to a main direction of extension of the lift rod. The “main extension plane” of an element or a component shall be understood in particular to mean a plane which is parallel to the largest lateral surface of the smallest imaginary cuboid which just completely encloses the element or component and which passes in particular through the center of the cuboid. The lift rod preferably has a circular cylindrical basic shape, with the lift rod being particularly preferably designed as a solid circle cylinder and most preferably as a hollow circle cylinder. It would also be conceivable for the lift rod to have a cross-section that deviates from a circle. The lift rod is preferably manufactured from metal, for example aluminum or steel. The lift rod is preferably connected at one axial end, in particular by force and/or material bonding, to the fork element and at the other axial end, in particular by force and/or material bonding, to the tool holder element.

The thrust crank unit for converting a rotary motion into an essentially linear oscillation is preferably designed as a Scotch yoke unit. The Scotch yoke unit is preferably designed as a circulating crank loop and is particularly preferably designed as an oscillating crank loop. The crank unit of the thrust crank unit is preferably designed as a disc of a cylinder and, in particular, has an axial length, especially in relation to an axis of rotation of the crank unit, of preferably at least 2 mm, preferably at least 5 mm, and particularly preferably at least 10 mm. In particular, a base area of the crank unit may be circular. It is also possible that the base area of the crank unit has a shape that deviates from a circle. Preferably, the crank unit is driven to rotate about an axis of rotation by a gear unit of the power tool. Preferably, the gear unit is designed as an angular gear. It would also be conceivable for the gear unit to be designed as a gear wheel gear. The axis of rotation preferably passes essentially perpendicular, in particular perpendicular, to the base area of the crank unit through a geometric center point of the crank unit. The thrust crank unit has a crank element with a crank axis. The crank axis preferably runs parallel to a longitudinal extension axis of the crank element and preferably parallel to the axis of rotation of the crank unit. The crank element is preferably arranged on a base area of the crank unit, particularly preferably in an edge region of the base area of the crank unit. In particular, the crank element can be permanently connected to the crank unit. It is also possible for the crank unit and the crank element to be manufactured in one piece. Alternatively, it is possible for the crank element to be arranged rotatably on the crank unit. The fork element is preferably intended to receive the crank element in the receiving region. The fork element preferably has plane-parallel surfaces, which are arranged essentially perpendicular to the axis of rotation of the crank unit. Preferably, the receiving region for the crank element is formed as a essentially rectangular recess in the fork element. The main direction of extension of the receiving region preferably runs in a plane parallel to the base area of the crank unit and perpendicular to the thrust direction.

The pendulum stroke unit is preferably designed to superimpose a pendulum stroke movement in a direction essentially parallel to the crank axis on an essentially linear oscillation in the thrust direction of the machining tool that is converted from a rotation by the thrust crank unit. The machining tool is preferably moved back and forth in the thrust direction by the linear oscillation, while the pendulum stroke movement moves the machining tool up and down essentially perpendicular to the thrust direction.

The first guide element with the first guide surface is preferably formed in one piece, in particular as a single part, with the crank element. In particular, the term “one-piece” is to be understood to mean at least materially bonded, for example, by a welding process, an adhesive process, an injection-molding process, and/or another process appearing suitable to the person skilled in the art, and/or advantageously formed in one piece, for example, by production from a casting and/or by production in a single or multi-component injection-molding process, and advantageously from a single blank. Advantageously, “in one piece” is also to be understood as “in one part.” In particular, “in one part” is to be understood as formed in one piece. Preferably, this one piece is produced from a single blank, a mass and/or a casting, more preferably in an injection-molding process, in particular, a single-and/or multi-component injection-molding process. It is also conceivable that the first guide element is designed as a separate component and is positively and/or non-positively connected to the crank unit. Preferably, the first guide surface of the first guide element is designed as a essentially flat surface. However, it would also be conceivable for the first guide surface to have a shape that differs from a flat surface. The second guide element with the second guide surface is preferably formed in one piece, in particular as a single part, with the fork element. It is also conceivable that the second guide element is designed as a separate component and is positively and/or non-positively connected to the fork element. Preferably, the second guide surface is designed as a surface that is at least partially inclined to the first guide surface. The term “inclined surface” refers to a surface that is inclined or unevenly aligned, in particular in relation to a reference surface, and whose inclination has a certain angle in relation to a horizontal or vertical reference axis. Preferably, the second guide surface is at least partially designed as an inclined surface with an angle of at least 2°, preferably of at least 10°, particularly preferably of at least 25°, in relation to the first guide surface. However, it is also conceivable that the second guide surface is at least partially designed as a curved surface and has a curved profile, for example. It is also conceivable that essentially the entire second guide surface is designed as an inclined surface to the first guide surface. The second guide surface is intended to direct movements or forces to guide the fork element in a specific direction when it abuts against the first guide surface. When the second guide surface of the second guide element abuts against the first guide surface of the first guide element, a pendulum stroke movement of the fork element is effected in a direction running essentially parallel to the crank axis, which is preferably transmitted via the lift rod to the machining tool arranged on the tool holder element.

It is further proposed that the second guide surface has at least one partial surface, which is designed as a flat surface lying parallel to the first guide surface, and at least one further partial surface, which is designed as a curved surface. Preferably, a boundary line between the partial surface and the further partial surface runs parallel to the main direction of extension of the lift rod. Preferably, a maximum area of the partial surface is more than 10 %, particularly preferably more than 25 % and particularly preferably more than 40 % of the second guide surface. Preferably, an area of the partial surface is at most 90%, preferably at most 75%, particularly preferably at most 60% of the second guide surface. Preferably, the further partial surface has a concave shape in relation to the second guide surface. Alternatively, a convex shape of the other partial surface in relation to the second guide surface would also be conceivable. However, it is also conceivable that the further partial surface could be designed as a plane that runs at an angle to the partial surface. Preferably, the flat partial surface merges seamlessly into the other, in particular curved, partial surface. Preferably, an angle of the further partial surface runs out to 0° in relation to the first partial surface at a transition to the first partial surface. It is particularly easy to provide a plurality of different movement profiles for a lifting movement. Particularly high flexibility can be achieved, which is especially advantageous. In addition, the efficiency of a cutting and/or sawing process can advantageously be improved.

In addition, it is proposed that the pendulum stroke unit has a spring element which is intended to exert a spring force on the second guide element. The spring element is designed to exert a spring force on the second guide element. A “spring element” is to be understood in particular as a macroscopic element which has at least one extension which in a normal operating state is elastically variable by at least 10%, in particular by at least 20%, preferably by at least 30% and particularly advantageously by at least 50%, and which in particular generates a counterforce which is dependent on a change in the extension and preferably proportional to the change and which counteracts the change. An “extension” of an element is to be understood in particular to mean a maximum distance between two points of a perpendicular projection of the element onto a plane. The term “macroscopic element” is in particular understood to mean an element having an extension of at least 1 mm, in particular at least 5 mm, and preferably at least 10 mm. Preferably, the spring element is designed as a compression spring which is supported against a housing portion of the power tool. In particular, the spring force is a normal force in relation to the partial surface of the second guide surface, which is designed as a flat surface and acts on the second guide element in a direction facing the first guide surface. In particular, the spring force causes the first guide surface and the second guide surface to abut against each other in at least one operating state. A particularly precise lifting movement can be carried out advantageously. Particularly advantageously, vibrations occurring during operation can be minimized and operator comfort can be improved.

Furthermore, it is proposed that the crank unit for absorbing an axial force has a bearing element, in particular an axial bearing element, which is connected to the gear unit, in particular by a material bond, with at least one support ring, which is designed as the first guide element. The axial bearing is designed to efficiently transmit an axial load in a direction parallel to the crank axis between the gear unit and the crank element. The axial bearing is preferably configured as an axial ball bearing. However, it is also possible for the axial bearing to be designed as an axial roller bearing, an axial plain bearing, an axial magnetic bearing or similar. Advantageously, the axial bearing keeps friction and wear to a minimum. In particular, an advantageously high service life and reliability are achieved.

It is further proposed that the pendulum stroke unit has a guide and/or bearing unit with at least one guide and/or bearing element, in particular a plain bearing, for guiding and/or bearing the lift rod and with at least one pivot point suspension element for supporting the lift rod so that it can rotate about an axis of rotation perpendicular to the main axis of extension of the lift rod. The guide and/or bearing unit is preferably intended to provide a guide and/or bearing for the lift rod. Preferably, the guide and/or bearing element is designed as a sleeve around the lift rod, in particular as a plain bearing. Preferably, the guide and/or bearing unit has a frame to which the at least one guide and/or bearing element and the pivot point suspension element are firmly connected, particularly preferably formed in one piece with the guide and/or bearing unit. The pivot point suspension element is preferably arranged in a close proximity to an axial end of the lift rod facing away from the fork element, in particular at a minimum distance of preferably less than 100 mm, preferably less than 50 mm and particularly preferably less than 20 mm. The pivot point suspension element is preferably used to rotatably support the guide and/or bearing element. Advantageously, the lift rod can be stored in a defined position. Particularly advantageous is the fact that friction and wear are kept to a minimum. Such an embodiment can advantageously change the direction of the linear oscillation of the lift rod in a plane perpendicular to an axis of rotation of the pivot point suspension element. The lift rod can be guided safely and with low friction during the pendulum stroke movement, which is particularly advantageous. In particular, an advantageously long service life can be achieved.

It is further proposed that the pendulum stroke unit has at least one adjusting element which is designed to adjust the thrust direction of the lift rod. Preferably, the adjusting element can be used to adjust a thrust direction of the lift rod in a direction that is essentially parallel to the crank axis. Preferably, the adjusting element is arranged in the vicinity of the fork element. The adjusting element can, for example, be designed as a screw thread in the guide and/or bearing unit, by means of which the position of the guide and/or bearing unit and thus the position of the lift rod can be changed. Particularly preferably, the thrust direction of the lift rod can be adjusted such that the first guide surface and the second guide surface do not abut against each other in at least one operating state, in particular do not touch each other during rotation of the crank unit. Preferably, the adjusting element has a handwheel. However, it would also be conceivable for the adjusting element to have a lever or another mechanism that would appear useful to a person skilled in the art. The adjusting element is preferably arranged on the housing of the power tool. This embodiment makes it easy to switch the lifting motion on and off.

Furthermore, it is proposed that the pendulum stroke unit has an adjustable slide element with at least two adjustment states, each of which defines a relative position of the first guide element and the second guide element in relation to each other. The adjustable slide element is used in particular for mechanical guidance, in particular mechanical guidance of the adjusting element, and preferably has a section in which the adjusting element can be moved, at least for each of the at least two adjusting states. Each of the sections preferably has a stop region for the adjusting element, wherein each stop region preferably has a stop surface arranged essentially parallel to the base area of the crank unit. Preferably, the stop surface for a first adjustment state has a smaller distance from the first guide surface than the stop surface for a second adjustment state. Preferably, the stop surface for the first adjustment state and the stop surface for the second adjustment state are arranged at a distance of at least 2 mm, preferably at least 5 mm, and particularly preferably at least 10 mm from each other in a direction perpendicular to the stop surfaces. Preferably, in a first adjustment state of the adjustment element, the first guide surface and the second guide surface abut against each other. In a second adjustment state of the adjusting element, the first guide surface and the second guide surface are preferably spaced apart from each other during a full rotation of the crank unit. The adjusting element can preferably be used to switch the pendulum stroke movement on or off. It is also conceivable that the adjustable slide element has more than two adjustment states, which has the advantage of allowing the magnitude of the pendulum stroke movement to be varied. Preferably, the adjustable slide element is designed as a single piece with the guide and/or bearing unit. However, it would also be possible for the adjustable slide element to be arranged as a separate component on the guide and/or bearing unit. It is also possible for the adjustable slide element to be arranged on the housing of the power tool or on another component of the power tool that appears sensible to a person skilled in the art. The adjustable slide element is preferably made of a metal, such as aluminum or steel. However, it would also be conceivable to provide an embodiment of the adjustable slide element from a plastic, such as a duromer, or a combination of materials that appear sensible to a person skilled in the art. Advantageously simple and particularly precise operation of the adjusting element can be provided.

It is also proposed that the adjusting element has an engagement element, in particular a bolt, which is designed to engage with the adjustable slide element, wherein in at least one adjustment state of the adjusting element, the first guide element and the second guide element abut against each other and in at least one further adjustment state, the first guide element and the second guide element are spaced apart from each other by a lift height H. The engagement element is preferably manufactured as a bolt. The engagement element is preferably made of metal. Alternatively, an engagement element made of plastic would also be conceivable. Preferably, the engagement element is formed integrally with the adjusting element. However, it would also be possible for the engagement element to be positively and/or non-positively connected to the adjusting element. For example, the engagement element could be provided with a screw thread and screwed into the adjusting element. Alternatively, the engagement element could be pressed and/or glued into an opening of the adjusting element in the form of a bolt. Preferably, the adjusting element comprises an actuating element, for example a hand rotating wheel, by means of which the adjusting element can be actuated by an operator. The operator can preferably rotate the actuating element to move the engagement element of the adjusting element from one adjustment state to another adjustment state. Preferably, the actuating element can be rotated in steps of at least 180°, preferably in steps of at least 90°, and particularly preferably in steps of at least 60°, in order to move the adjusting element from one adjustment state to another adjustment state. The lift height H is preferably defined by the distance between the stop surface for the first adjustment state of the adjustable slide element and the stop surface for the second adjustment state of the adjustable slide element in a direction perpendicular to the stop surfaces. In one adjustment state, in particular in the adjustment state in which the first guide surface and the second guide surface abut against each other, the lift height H is preferably essentially 0 mm. Preferably, the lift height H in at least one further adjustment state is at least 2 mm, preferably at least 5 mm, and particularly preferably at least 10 mm. Such an embodiment has the advantage of achieving a particularly reliable adjustment of the pendulum stroke movement.

In addition, the disclosure is based on a pendulum stroke unit for a pendulum stroke device, in particular for a pendulum stroke device according to the disclosure. This enables advantageous and efficient sawing and/or cutting. Furthermore, existing pendulum stroke devices can be retrofitted with the pendulum stroke unit according to the disclosure in an advantageous, cost-effective manner and with little effort. High sustainability can be advantageously achieved.

Furthermore, the disclosure is based on a power tool, in particular a sawing machine, with a pendulum stroke device, in particular a pendulum stroke device according to the disclosure. The power tool is preferably designed as a hand-held power tool. The power tool is preferably designed as a sawing machine, in particular a hand-held sawing machine. It is also conceivable that the power tool has a different embodiment that appears sensible to a person skilled in the art, such as an embodiment as a garden cultivation machine, a multifunctional machine tool, or the like.

The pendulum stroke device, pendulum stroke unit, and/or power tool according to the disclosure should not be limited to the application and embodiment described above. In particular, the pendulum stroke device, the pendulum stroke unit, and/or the power tool according to the disclosure may have a number of individual elements, components, and units that differs from the number specified in order to fulfill a function described herein. Additionally, regarding the ranges of values indicated in this disclosure, values lying within the limits specified hereinabove are also provided to be considered as disclosed and usable as desired.

### BRIEF DESCRIPTION OF THE DRAWINGS

Further advantages follow from the description of the drawings below. An exemplary embodiment of the disclosure is shown in the drawing. The drawings, the description, and the claims contain numerous features in combination. A person skilled in the art will appropriately also consider the features individually and combine them into additional advantageous combinations.

The drawings show:

FIG. 1 a power tool according to the disclosure,

FIG. 2 a cutout of the power tool according to the disclosure with a pendulum stroke device according to the disclosure in a schematic partial section view,

FIG. 3 a fork element of a pendulum stroke device according to the disclosure with a second guide element and a second guide surface in a schematic representation,

FIG. 4 a cutout of the pendulum stroke device according to the disclosure with a pendulum stroke unit according to the disclosure in a schematic partial section view,

FIG. 5 a pendulum stroke device according to the disclosure with a thrust crank unit, a pendulum stroke unit and a guide and/or bearing unit in a schematic representation,

FIG. 6a a schematic representation of the interaction of the first and second guide surfaces of a pendulum stroke device according to the disclosure in a view of a thrust crank unit of the pendulum stroke device according to the disclosure in a direction parallel to a thrust direction, in a first position,

FIG. 6b a schematic representation of the interaction of the first and second guide surfaces of FIG. 6a in a direction parallel to a thrust direction, in a second position,

FIG. 6c a schematic representation of the interaction of the first and second guide surfaces of FIG. 6a in a plan view looking in direction “A”, in the first position, and

FIG. 6d a schematic representation of the interaction of the first and second guide surfaces of FIG. 6a in the plan view looking in direction “A”, in the second position.

### DETAILED DESCRIPTION

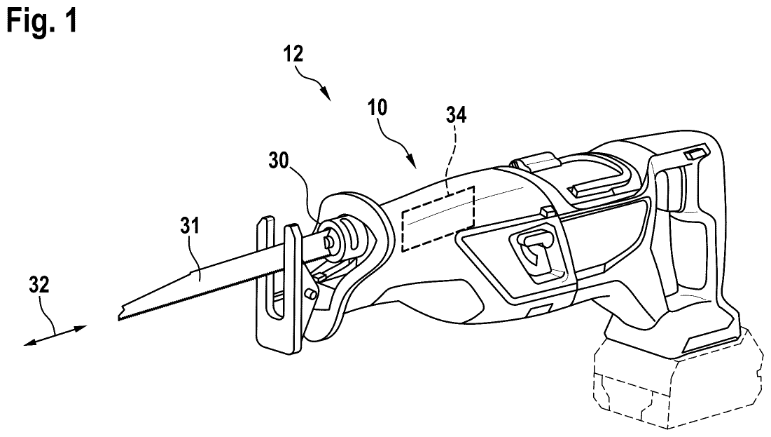

FIG. 1 shows a power tool 12, in particular a sawing machine, with a pendulum stroke device 10. The power tool 12 is configured as a hand-held power tool. The power tool 12 is designed as an electric sawing machine, in particular as a battery-powered sawing machine. The power tool 12 is designed as a reciprocating saw, in particular a battery-powered reciprocating saw. However, it would also be conceivable for the power tool 12 to be designed as a jigsaw. Alternatively, it would also be conceivable for the power tool 12 to be designed as a fuel-powered sawing machine, a compressed air-powered sawing machine, or the like. The pendulum stroke device 10 is fixedly arranged in a housing of the power tool 12. FIG. 1 also shows a machining tool 31, in particular a saw blade, which is detachably connected to the power tool 12. The power tool 12 has a tool holder element 30 which is designed to hold the machining tool 31 by means of a quick-release fastener, in particular for holding saw blades with an S-shank. Alternatively, it would also be possible for the tool holder element 30 to have a screw for fixing a machining tool 31. The machining tool 31 is designed to saw wood, metal, plastic, or similar materials in operation. Alternatively, however, it is also conceivable, particularly depending on the embodiment of the power tool 12, that the machining tool 31 is designed as a cutting tool or a grinding tool.

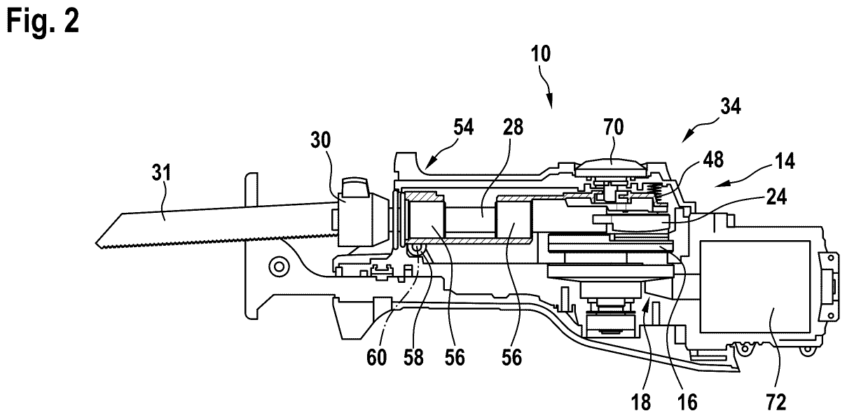

FIG. 2 shows a cutout of the power tool 12. The power tool 12 has a drive unit 72. The drive unit 72 is formed by an electric motor. The drive unit 72 is fixedly arranged in the housing of the power tool 12. Preferably, an axis of rotation of the drive unit 72 is aligned essentially parallel to a longitudinal axis of the power tool 12. Furthermore, the power tool 12 has a gear unit 18. The gear unit 18 is exemplarily formed by an angular gear. The gear unit 18 has a first gear element that is connected in a rotationally fixed manner to an output shaft of the drive unit 72. The first gear element is formed in particular by a bevel gear. Furthermore, the gear unit 18 has a second gear element. The second gear element is also formed by a bevel gear. The gear unit 18 is provided for deflecting and reducing the drive movement of the drive unit 72.

The pendulum stroke device 10 of the power tool 12 is shown in FIG. 2 in an installed position. The pendulum stroke device 10 is housed in the housing of the power tool 12. The machining tool 31 is housed in the tool holder element 30. The pendulum stroke device 10 has a thrust crank unit 14, which is designed as a Scotch yoke unit, for converting a rotary motion into at least substantially linear oscillation. The thrust crank unit 14 has a crank unit 16 which can be actuated by the gear unit 18 of the power tool 12 driven by the drive unit 72. The crank unit 16 is connected in a rotationally fixed manner to the second gear element of the gear unit 18. The crank unit 16 is designed as a disc of a cylinder with a circular base and has an axial length of at least 3 mm, preferably at least approximately 5 mm. The crank unit 16 is manufactured from metal. The crank unit 16 is driven by the gear unit 18 of the power tool 12 to rotate about an axis of rotation 68. The thrust crank unit 14 further comprises a crank element 20 with a crank axis 22, which is arranged parallel to and offset from the axis of rotation 68 of the crank unit 16. The crank element 20 is arranged on a base area of the crank unit 16 in an edge region of the base area of the crank unit 16 so as to be rotatable about the crank axis 22. The crank element 20 is arranged on a side of the crank unit 16 facing away from the second gear element. The crank element 20 is formed by a circular cylindrical element rotatably mounted on the crank unit 16. The thrust crank unit 14 converts a rotary motion into an at least essentially linear oscillation with a thrust direction 32 running essentially perpendicular to the crank axis 22. The thrust crank unit 14 has a fork element 24 which defines a receiving region 26 for receiving the crank element 20. The fork element 24 is designed as a component with a essentially oval basic shape and has plane-parallel surfaces which are arranged perpendicular to the axis of rotation 68 of the crank unit 16. The fork element 24 is manufactured from steel. However, it would also be conceivable that the fork element 24 is manufactured from another metal or other material. The receiving region 26 is essentially rectangular in shape and has a main direction of extension that runs in a plane parallel to the base area of the crank unit 16 and perpendicular to the thrust direction 32. The pendulum stroke device 10 further has a lift rod 28, which is connected at one axial end to the fork element 24, for transmitting the linear oscillation to the tool holder element 30 of the power tool 12 with a thrust direction 32 running essentially parallel to a main direction of extension of the lift rod 28. At the other axial end, the lift rod 28 is firmly connected to the tool holder element 30. In this case, the lift rod 28 is manufactured from metal, in particular aluminum, in the form of a hollow cylindrical rod.

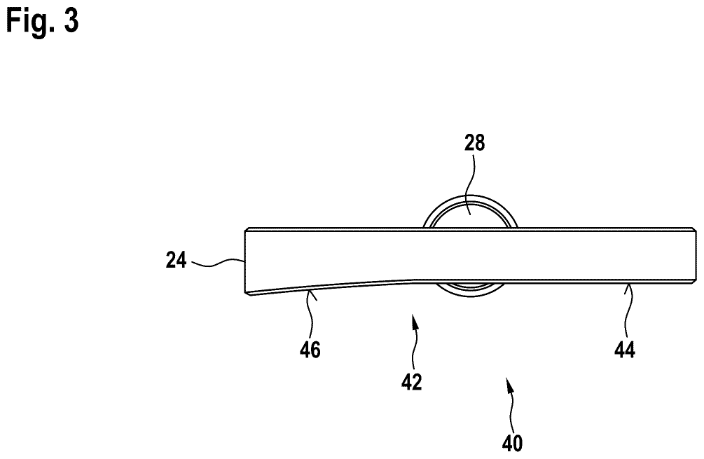

The pendulum stroke device 10 has a pendulum stroke unit 34. The pendulum stroke unit 34 has a first guide element 36, which is fixedly connected to the crank unit 16 and has a first guide surface 38 extending essentially perpendicular to the crank axis 22, and a second guide element 40 facing the first guide element 36 and fixedly connected to the fork element 24, which has a second guide surface 42 that is at least partially oblique relative to the first guide surface 38 and which, in at least one operating state, is designed to abut against the first guide surface 38 and, when the crank unit 16 is rotated, to cause a pendulum stroke movement of the fork element 24 in a direction that runs essentially parallel to the crank axis 22. In the present case, the first guide surface 38 of the first guide element 36 is designed as a flat surface. The second guide element 40 with the second guide surface 42 is preferably designed as a single piece with the fork element 24 (see also FIG. 3). The second guide surface 42 has a partial surface 44, which is designed as a flat surface parallel to the first guide surface 38, and a further partial surface 46, which is designed as a curved surface. In the present case, the further partial surface 46 has an inclination with an angle of 25° in relation to the first guide surface 38. However, a curved profile for the further partial surface 46 would also be conceivable. The areas of the partial surface 44 and the further partial surface 46 each amount to 50% of the area of the second guide surface 42. The angle of inclination of the further partial surface 46 approaches 0° at a transition to the partial surface 44, so that there is no edge between the partial surface 44 and the further partial surface 46.

The pendulum stroke unit 34 has a spring element 48 which is designed to exert a spring force on the second guide element 40. The spring element 48 is designed as a compression spring, in particular as a coil spring. The spring element 48 is supported against a housing portion of the power tool 12 and exerts a normal force on the second guide element 40 such that the first guide surface 38 and the second guide surface 42 abut against each other in at least one operating state. However, it would also be conceivable to envisage an embodiment of spring element 48 as a tension spring in order to exert a normal force on the second guide element 40 such that the first guide surface 38 and the second guide surface 42 abut against each other in at least one operating state.

The pendulum stroke unit 34 comprises a guide and/or bearing unit 54 with a guide and/or bearing element 56.

The guide and/or bearing unit 54 is designed to guide and/or bear the lift rod 28. In the present case, the guide and/or bearing unit 54 has two guide and/or bearing elements 56, which are designed as plain bearings, in which the lift rod 28 is arranged so that it can move with low friction in the thrust direction 32. The guide and/or bearing elements 56 are firmly connected to each other and spaced apart along an axial extension of the lift rod 28. However, it would also be conceivable for the guide and/or bearing unit 54 to comprise a guide and/or bearing element 56, in particular a plain bearing, which extends over a length of at least 25% of the total length of the lift rod 28. The guide and/or bearing unit 54 further has a pivot point suspension element 58 for supporting the lift rod (28) so that it can rotate about an axis of rotation 60 perpendicular to the main axis of extension of the lift rod 28. The pivot point suspension element 58 is arranged in a close proximity to the axial end of the lift rod 28 facing the tool holder element 30. The pivot point suspension element 58 is designed as an axle sleeve and can be arranged on a corresponding axis arranged on the housing of the power tool 12 so as to be rotatable about the axis of rotation 60.

The pendulum stroke unit 34 has an adjusting element 62 which is designed to adjust the thrust direction of the lift rod 28. The adjusting element 62 is arranged in the vicinity of the fork element 24. The adjusting element 62 can be designed as a screw thread in the guide and/or bearing unit 54, by means of which the position of the guide and/or bearing unit 54 and thus the position of the lift rod 28 can be changed. The adjusting element 62 adjusts the thrust direction 32 of the lift rod 28 by adjusting the guide and/or bearing unit 54 in which the lift rod 28 is guided and/or mounted. When the adjusting element 62 is actuated, a position of the guide and/or bearing unit 54 is achieved by a rotation about the axis of rotation 60 of the pivot point suspension element 58. This adjusts the position of the lift rod 28 such that the first guide surface 38 and the second guide surface 42 do not abut against each other in at least one operating state, and in particular do not touch each other during rotation of the crank unit 16. In this case, the adjusting element 62 has a hand wheel arranged on the housing of the power tool 12. However, an embodiment of the adjusting element 62 with an adjusting lever or the like would also be conceivable.

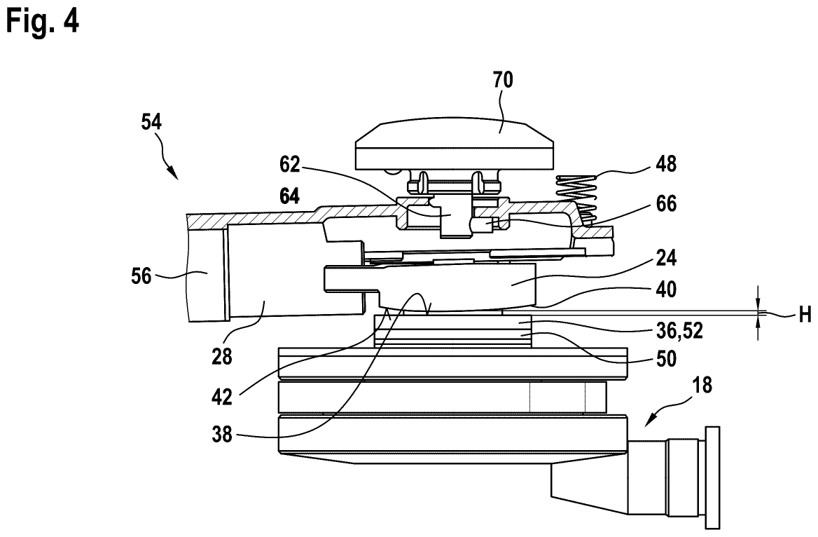

The pendulum stroke unit 34 has an adjustable slide element 64 with two adjustment states, each of which defines a relative position of the first guide element 36 and the second guide element 40 in relation to each other (see FIG. 4). The adjustable slide element 64 is designed to mechanically guide the adjusting element 62 and, with the two adjustment states, to define a relative position of the first guide element 38 and the second guide element 42 in relation to each other. In this case, the adjustable slide element 64 is designed as a single piece with the guide and/or bearing unit 54. Switching between the two settings activates or deactivates the pendulum stroke movement. The adjustable slide element 64 has a region for each of the at least two adjustment states in which the adjusting element 62 can be moved. Each of the regions has a stop region for the adjusting element 62, wherein each stop region preferably has a stop surface arranged essentially parallel to the base area of the crank unit 16. The stop surface for a first adjustment state is at a smaller distance from the first guide surface 38 than the stop surface for a second adjustment state. The stop surface for the first adjustment state and the stop surface for the second adjustment state are arranged at a distance of at least 5 mm from each other in a direction perpendicular to the stop surfaces. In a first adjustment state of the adjusting element 62 in the adjustable slide element 64, the first guide surface 38 and the second guide surface 42 abut against each other. In a second adjustment state of the adjusting element 62 in the adjustable slide element 64, the first guide surface 38 and the second guide surface 42 are spaced apart from each other during a full rotation of the crank unit 16, in particular not in contact with each other. It is also conceivable that the adjustable slide element 64 has more than two adjustment states, whereby a magnitude of the pendulum stroke movement can be changed. The adjusting element 62 has an engagement element 66, in particular a bolt, which is intended to engage with the adjustable slide element 64, wherein in at least one adjustment state of the adjusting element 62, the first guide element 36 and the second guide element 40 are in contact with each other and in at least one further adjustment state, the first guide element 36 and the second guide element 40 are mutually spaced apart by a lift height H. The engagement element 66 is designed as a bolt made of metal. Alternatively, an engagement element made of plastic would also be conceivable. In this case, the engagement element 66 is designed as a single piece with the adjusting element 62. The adjusting element 62 has an actuating element 70, which is designed as a hand wheel, by means of which the adjusting element 62 can be actuated by an operator and the engagement element 66 can be transferred from one adjustment state of the adjustable slide element 64 to another adjustment state. In the present case, the adjusting element 62 is transferred from one adjustment state to another adjustment state by rotating the actuating element 70 through 90°.

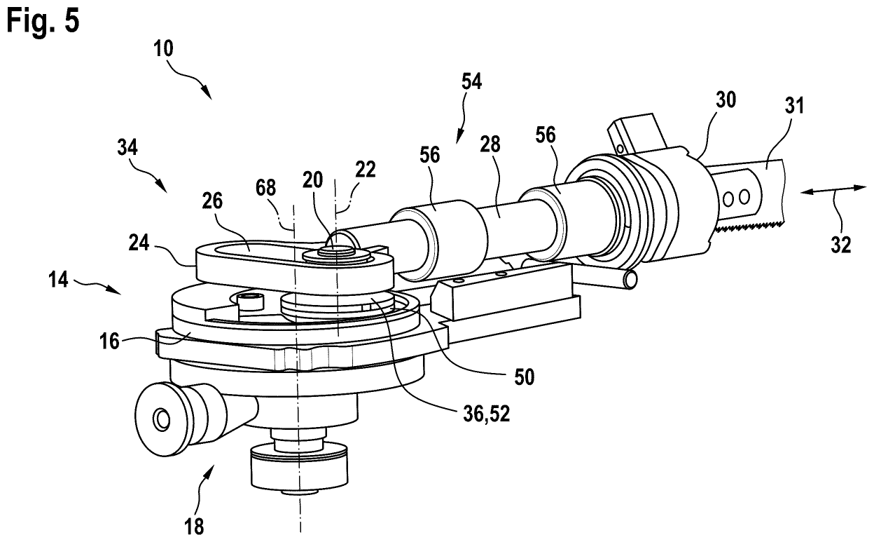

The crank unit 16 has a bearing element 50 for absorbing an axial force, which is connected to the second gear element of the gear unit 18, which has a support ring 52 that is designed as the first guide element 36 (see also FIG. 5). The bearing element 50 is designed as an axial ball bearing in the present case. Alternatively, however, it would also be conceivable for the bearing element 50 to be designed as an axial plain bearing.

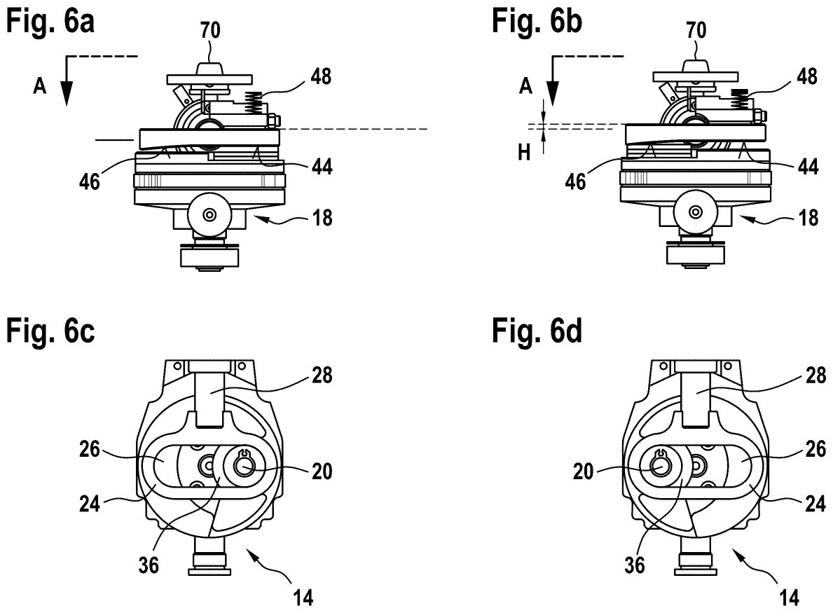

FIGS. 6a-6d show a schematic representation of the interaction between the first guide surface 38 of the first guide element 36 and the second guide surface 42 of the second guide element 40. FIGS. 6a and 6b show a view of the thrust crank unit 14 along a direction facing the machining tool 31 and running parallel to the axis of rotation 68. FIGS. 6a and 6b also show the adjusting element 62 of the pendulum stroke unit 34 for adjusting the thrust direction 32 of the lift rod 28 and the spring element 48, which is designed to exert a spring force on the second guide element 40. FIGS. 6c and 6d show a view of the thrust crank unit in a direction A, as indicated in FIGS. 6a and 6b. FIG. 6a shows that the crank element 20 is arranged in the receiving region 26 of the fork element 24 and the crank unit 16 is in a position relative to rotation about the axis of rotation 68 in which, as shown in FIG. 6c, the partial surface 44 of the second guide surface 42 rests against the first guide surface 38. The crank unit 16 has the bearing element 50 for absorbing axial loads, which is connected to the gear unit 18 by a material bond, with the support ring 52, which is designed as the first guide element 36. The first guide element 36 has a flat first guide surface 38 extending perpendicular to the crank axis 22. The second guide surface 42 has the partial surface 44 and the further partial surface 46, wherein the further partial surface 46 is formed as a curved surface with a concave profile. When the crank unit 16 rotates clockwise from the position shown in FIGS. 6a and 6c to the position shown in FIGS. 6b and 6d, the crank element 20 moves from one side of the receiving region 26 of the fork element 24 to the other side of the receiving region 26. When the crank element 20 is rotated clockwise, the fork element 24 is moved in a direction away from the machining tool 31 parallel to the main direction of extension of the lift rod 28. Furthermore, the abutment of the second guide surface 42 with the first guide surface 38 moves the fork element 24 in a direction away from the first guide element 36 parallel to the crank axis 22. The machining tool 31, which is arranged on the tool holder element 30 arranged on the lift rod 28, thus performs a movement in the direction of the crank unit 16 when the crank unit 16 rotates clockwise from the position shown in FIGS. 6a and 6c to the position shown in FIGS. 6b and 6d, which is superimposed with a pendulum stroke movement in a direction facing a workpiece to be machined. Actuating the adjusting element 62 by a user adjusts the thrust direction 32 of the lift rod 28 such that the second guide surface 42 is spaced apart from the first guide surface 38 by a lift height H. In this adjustment state of the adjusting element 62, the pendulum stroke movement of the pendulum stroke unit 34 is switched off.

What is claimed is:

1. A pendulum stroke device for a power tool, comprising:
a thrust crank unit configured to convert rotary motion into at least essentially linear oscillation, wherein the thrust crank unit includes (i) at least one crank unit configured to be actuated by a gear unit of the power tool, (ii) at least one crank element having a crank axis, and (iii) at least one fork element which is bounded by a receiving region for the crank element;
at least one lift rod connected at one axial end to the fork element and configured to transmit linear oscillation to a tool holder element of the power tool with a thrust direction running essentially parallel to a main direction of extension of the lift rod; and
at least one pendulum stroke unit which has (i) at least one first guide element formed integrally with the crank unit and having a first guide surface extending essentially perpendicular to the crank axis, and (ii) at least one second guide element facing the first guide element and at least firmly connected to the fork element and having a second guide surface that is at least partially oblique to the first guide surface and which is configured to, in at least one operating state, abut against the first guide surface and, when the crank unit is rotated, to cause a pendulum stroke movement of the fork element to run in a direction running essentially parallel to the crank axis.

2. The pendulum stroke device according to claim 1, wherein the second guide surface has (i) at least one partial surface which is designed as a flat surface parallel to the first guide surface, and (ii) at least one further partial surface which is designed as a curved surface.

3. The pendulum stroke device according to claim 1, wherein the pendulum stroke unit has a spring element which is designed to exert a spring force on the second guide element.

4. The pendulum stroke device according to claim 1, wherein:
the crank unit is configured to absorb an axial force, and
the crank unit has an axial bearing element which is connected to the gear unit and at least one support ring which is designed as the first guide element.

5. The pendulum stroke device according to claim 1, wherein the pendulum stroke unit has a guide and/or bearing unit with at least one guide and/or bearing element for guiding and/or bearing the lift rod, and at least one pivot point suspension element for supporting the lift rod so that it can rotate about an axis of rotation perpendicular to the main axes of extension of the lift rod.

6. The pendulum stroke device according to claim 1, wherein the pendulum stroke unit has at least one adjusting element which is designed to adjust the thrust direction of the lift rod.

7. The pendulum stroke device according to claim 1, wherein the pendulum stroke unit has an adjustable slide element with at least two adjustment states, each of which defines a relative position of the first guide element and the second guide element in relation to each other.

8. The pendulum stroke device according to claim 6, wherein the adjusting element has an engagement element which is designed to engage in the adjustable slide element, and wherein in at least one adjustment state of the adjusting element, the first guide element and the second guide element abut against each other and, in at least one further adjustment state, the first guide element and the second guide element are mutually spaced by a lift height H.

9. A pendulum stroke unit for the pendulum stroke device according to claim 1.

10. A power tool having at least one pendulum stroke device according to claim 1.

11. The pendulum stroke device according to claim 1, wherein the power tool is a sawing machine.

12. The pendulum stroke device according to claim 1, wherein the thrust crank unit is a Scotch yoke unit.

13. The pendulum stroke device according to claim 1, wherein the axial bearing element is connected to the gear unit by a material bond.

14. The pendulum stroke device according to claim 6, wherein the engagement element is a bolt.

15. The power tool according to claim 10, wherein the power tool is a sawing machine.
